(19) United States
(12) Patent Application Publication
(10) Pub. No.: US 2005/0182609 A1
(43) Pub. Date: Aug. 18, 2005

(54) Method and system for simulating a manual operating device

(75) Inventors: Frank Kurrle, Pleidelsheim (DE); Frank Sayer, Trossingen (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c. F. Porsche Aktiengesellschaft, Stuttgart (DE)

(21) Appl. No.: 11/055,410

(22) Filed: Feb. 11, 2005

(30) Foreign Application Priority Data
Feb. 14, 2004 (DE) 10 2004 007 295.7

(51) Int. Cl. G06F 19/00

(52) U.S. Cl. 703/8

(57) ABSTRACT

A system for the simulation of a manual operating device has a lever with an upper and a lower end which has a first axis of rotation extending essentially perpendicular to the longitudinal dimension of the lever and a second axis of rotation extending essentially perpendicular to the first axis of rotation and to the longitudinal dimension of the lever. A rotatory servo motor is coupled on the rotor side to the second axis of rotation of the lever, for providing a predetermined torque at a predetermined actual angular position of the lever. A linear motor which is coupled on the rotor side with the lever, for providing a predetermined force at a predetermined actual position of the lever.

This application claims the priority of German Application No. 10 2004 007 295.7 filed Feb. 14, 2004, the disclosure of which is expressly incorporated by reference herein.

The present invention relates to a method and to a system for simulating a manual operating device, and particularly to a method and a system for simulating the shifting haptics of a manual transmission in a motor vehicle.

For reducing the development expenditures specifically in the field of motor vehicle construction, efforts are rapidly being made to simulate the behavior of diverse components or also of the handling of the entire vehicle on computer systems. Furthermore, particularly in the premium segment of motor vehicle construction, the operating comfort or operating haptics of the devices to be operated play an increasingly important role.

From British Published Patent Application GB 2 036 404, a simulator is known for simulating the shifting haptics of a motor vehicle transmission. The simulator corresponds essentially to a real transmission or to the external gear shift mechanism of the transmission. In addition to mechanical power transmission elements, a pneumatic device is provided which reflects the behavior of the transmission during the shifting. As a result, the rough movements of the gear shift lever are implemented.

In German Published Patent Application DE 198 55 072, a system is disclosed for simulating a force, particularly a shifting force of a transmission simulator which has a movably disposed adjusting element which can be acted upon by means of a force generator counteracting an adjustment of the adjusting element. Furthermore, a transmission and driving simulator is described which has the device for simulating a force by means of the elastic force generator. This simulation system is also only suitable for simulating the haptics of rough movements of the gear shift lever.

From German Published Patent Document DE 38 08 004 (corresponding U.S. Pat. No. 4,849,888), a method and a system are known for evaluating the shifting-operation sensitivity of a transmission to be shifted manually, which is equipped with a gear shift lever and a synchronous transmission device, one of several gear trains in the transmission to be shifted manually being changed into a power transmission condition by means of the synchromesh transmission device, for measuring at least the load by which the gear shift lever is acted upon during a predetermined period within the time for the shifting operation of the gear shift lever. This complex system for evaluating the shifting-operation sensitivity is coupled with a real mechanical transmission which represents a cost-intensive system for the reproduction of predetermined shifting haptics, which can be modified as desired only at very high expenditures with respect to the shifting haptics.

In contrast to the known solution attempts, the system according to the invention for simulating a manual operating device, as well as the method according to the invention, has the advantage that the simulation of a manual operating device is provided without complex mechanical elements of the operating device. According to certain preferred embodiments of the invention, there is provided a system for the simulation of a manual operating device comprising a lever with an upper and a lower end which has a first axis of rotation extending essentially perpendicular to a longitudinal dimension of the lever and a second axis of rotation extending essentially perpendicular to the first axis of rotation and to the longitudinal dimension of the lever, a rotatory servo motor which is coupled on a servo motor rotor side to the second axis of rotation of the lever, for providing a predetermined torque at a predetermined actual angular position or actual speed of the lever, and a linear motor which is coupled on a linear motor rotor side with the lever, for providing a predetermined force at a predetermined actual position or actual angular position of the lever.

According to certain preferred embodiments of the invention, there is provided a simulation system providing a lever having an upper and a lower end, and a first axis of rotation being situated essentially perpendicular to a dimension of the lever, and the second axis of rotation being situated essentially perpendicular to the first axis of rotation and to the dimension of the lever. Thus according to certain preferred embodiments of the invention, particularly no external gear shift mechanism, that is, no reversing levers, bowden cable or gear shift linkage of a real transmission, is required for the simulation system. Except for a shift lever, all components of the operating device, preferably of a vehicle manual transmission, are simulated by way of software, by means of a mathematical model on a computer device and are simulated by a rotatory servo motor as well as a linear motor. In the case of the simulation in the mathematical model, particularly the behavior of the entire transmission line under real conditions as well as the influence of the overall vehicle on the transmission line, are taken into account. The dynamic behavior of a real mechanical manual transmission is therefore reproduced in real time.

An idea on which certain preferred embodiments of the present invention is based comprises coupling two electrically controllable actuators to a real lever rotatably disposed in two directions and to dynamically control the actuators such that the operating haptics of the real operating device are precisely reproduced. In this case, the simulation model, which is present as a mathematical model on a computer device, is capable of computing the mechanical quantities, that is, the forces, for example, at the operator's hand in real time and to emit them to the actuators as a function of their actual position or angular position as well as the actual speed or the actual angular velocity.

In other words, according to certain preferred embodiments of the invention, a system for simulating a manual operating device is provided having: a lever with an upper and a lower end, which has a first axis of rotation essentially perpendicular to the longitudinal dimension of the lever and a second axis of rotation essentially perpendicular to the first axis of rotation and to the dimension of the lever; a rotatory servo motor which is coupled on the rotor side to the second axis of rotation of the lever, for providing a predetermined torque at a predetermined angular position of the lever in the direction of the second axis of rotation; and a linear motor, which, on the rotor side, is coupled with the lever, for providing a predetermined force at a predetermined actual position and/or the actual speed of the lever.

Advantageous developments and further developments of the system and the method for simulating a manual operating device, according to certain preferred embodiments of the invention, are described herein and in the claims.

According to certain preferred embodiments of the invention, the rotatory servo motor is coupled directly to the second axis of rotation, and the linear motor is coupled by way of a connecting rod to a lower end of the lever, the lever extending by means of the lower end beyond the first axis of rotation.

According to certain preferred embodiments of the invention, the linear motor and the rotatory servo motor are in each case connected to a driver stage for providing a predetermined current as a function of the respective actual-position/angular position of the lever.

According to certain preferred embodiments of the invention, a common interface device is provided for the output of one desired current value respectively as a function of the actual position of the linear motor and of the angular position of the rotatory servo motor.

According to certain preferred embodiments of the invention, the interface device is connected with a computer device for detecting actual values and for the computing and output of desired values in real time, preferably consisting of a unit.

According to certain preferred embodiments of the invention, a force detection device is provided on the lever, for detecting at least one feedback variable for computing the desired values in the computer device.

According to certain preferred embodiments of the invention, the force detection device has strain gauges and preferably measuring amplifiers for detecting the bending of the lever.

According to certain preferred embodiments of the invention, the lever, the linear motor and the rotatory servo motor are mutually mechanically coupled by way of a rigid carrier device.

According to certain preferred embodiments of the invention, a desired-force/torque value of the motors is determined on a computer device as a function of an actual position of the linear motor, of the angular position of the rotatory servo motor and of an actual force acting upon the lever, by means of a math model in real time.

According to certain preferred embodiments of the invention, the force/torque value computed in real time is transmitted by way of a force/torque controller to an interface device, which in each case controls a motor end stage of the linear motor and of the rotatory servo motor, for providing a corresponding current for generating the force/torque.

According to certain preferred embodiments of the invention, data and parameters, which are generated and/or required and/or processed during the simulation, are monitored and/or changed by way of an operating surface as a software tool on a computer device.

According to certain preferred embodiments of the invention, the haptics of a real motor vehicle transmission are simulated.

According to certain preferred embodiments of the invention, a simulated driving speed and/or tractive resistances, particularly air friction and/or a gradient, and/or the position of a simulated clutch and/or a rotational engine speed and/or distortions in the transmission line during simulated cornering also flow into the simulation of the shifting haptics for a motor vehicle transmission.

According to certain preferred embodiments of the invention, a feedback variable is obtained by way of strain gauges on the lever, which feedback variable is used during a desired-value determination for controlling the motors in a computer device.

By means of the simulation method according to the invention and the simulation system according to the invention respectively, each manual gear shift transmission can be simulated without a required hardware adaptation. According to certain preferred embodiments of the invention, simulation models of the transmission line consisting of the clutch, the tires and the transmission of the overall vehicle are developed simultaneously with its construction. Correspondingly, the haptics, that is, the shifting touch for the driver, which depends on the respective transmission, can be checked and verified directly, particularly in the individual development phases. The moving-out of optimal parameters for the construction, for example, of the transmission, is permitted. A definition of shifting characteristics typical of the make or the vehicle can be provided, in which case cost-intensive construction stages or prototypes of the gear shift mechanism relating to the simulation of the shifting haptics can be saved.

In addition, measures suggested in the development process of a transmission can be tested directly for improving the shifting quality/haptics without requiring cost-intensive prototypes, time-intensive modification measures and/or cost-intensive test stand runs. As another advantage, it is easier for the development team of the transmission to make decisions as to whether a new construction of a transmission prototype is worthwhile, when improvements/changes are to be tested which, at the actual point in time, do not exist in real hardware; that is, whether changes on the transmission and/or the transmission line really lead to the endeavored goal of modified shifting haptics. According to certain preferred embodiments of the invention, in addition to an active shifting with simulated shifting haptics, measured sequences, for example, from a rear vehicle or of a test stand, can also be played back because the used actuators can freely move the gear shift lever within the scope of their respective degree of freedom.

According to certain preferred embodiments of the invention, the subjective consideration of the shifting touch or of the shifting haptics can become objective. The shifting sequence, which takes place in real time, permits a reaction to the driver's behavior; that is, a loose/firm grip with much/little force when shifting slowly/fast. Furthermore, the compact simulation system can be integrated, for example, in a total vehicle simulator and is portable.

An embodiment of the invention is illustrated in the drawing and will be explained in detail in the following description.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic diagonal top view of a detail of a simulation system for explaining an embodiment of the present invention;

FIG. 2 is a schematic block diagram of a simulation system for explaining the method of operation of an embodiment of the present invention;

FIG. 3 is a schematic block diagram for explaining the method of operation of an embodiment of the present invention; and

FIG. 4 is a schematic block diagram for explaining an embodiment of the present invention.

### DETAILED DESCRIPTION OF THE DRAWINGS

In the figures, the same reference numbers indicate identical components or components having the same function.

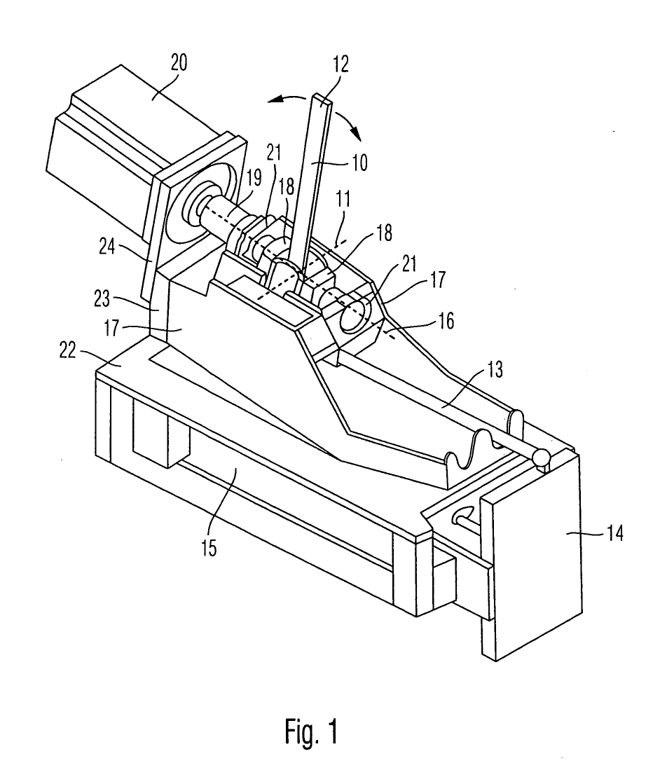

FIG. 1 is a schematic diagonal top view of a detail of a simulation system according to a preferred embodiment of the present invention. A lever 10, particularly a gear shift lever, is rotatably disposed by way of a first axis of rotation 11 which is situated transversely to the longitudinal dimension of the lever 10. The lever 10 has an upper end 12 and a lower end (not shown in FIG. 1). According to FIG. 1, the lower end of the lever 10 is coupled by way of a connecting rod 13 to the rotor 14 of a linear motor 15. The lever 10 is rotatably by way of a second axis of rotation 16 disposed in a carrier device 17. The second axis of rotation 16 extends perpendicular to the dimension of the lever 10 and perpendicular to the first axis of rotation 11 in the longitudinal direction essentially parallel to the connecting rod 13. The lower end (not shown) of the lever 10 extends beyond the first axis of rotation 11 downward. The first axis 11 and the second axis 16 of rotation preferably form a common point of intersection. By way of a guiding device 18, which accommodates the first axis of rotation 11 and is rotatably disposed along the second axis of rotation 16, the lever 10 is guided in a movable manner.

By way of a shaft 19, which is non-rotatably connected with the rotatably disposed guiding device 18, a rotatory servo motor 20 is non-rotatably coupled in the direction of the first axis of rotation 16. By means of bearing devices 21, the shaft 19 is rotatably disposed in the rotating direction of the second axis of rotation 16. In this case, for example, ball bearings, roller bearings or slide bearings are used. The carrier device 17 is rigidly coupled to a carrier plate 22 by way of which the linear motor 15 is rigidly connected, preferably screwed directly to the carrier device 17. The rotatory servo motor 20 is also rigidly coupled to the carrier device 17, preferably screwed to it directly or by way of at least one intermediate piece or adapter piece 23, 24.

When the lever 10 is pushed in the direction of the arrow about the first axis of rotation 11 at the upper end 12 toward the front or rear, the lower end (not shown) of the lever 10 correspondingly moves in the opposite direction, which, by way of the connecting rod 13, is correspondingly transmitted to the rotor 14 of the linear motor 15. When, at its upper end 12, the lever 10 is moved about the second axis of rotation 16 toward the left or right, this movement is transmitted directly to the rotatably disposed guiding device 18 and the shaft 19 which is non-rotatably connected with the shaft of the rotor (not shown) of the rotatory servo motor 20. By way of the angular position of the rotor of the rotatory servo motor 20 as well as by way of the actual position of the rotor 14 of the linear motor 15, the position of the lever 10 is precisely defined.

At predetermined angular positions of the lever 10, by means of an intelligent control of the rotatory servo motor 20, a torque can now be generated which counteracts an operator's operating force on the lever 10. In this manner, lateral stops and predetermined lateral forces can be simulated which have to be applied by an operator for the lateral movement of the lever 10. Similarly, by way of an intelligent control of the rotor 14 of the linear motor 15, as a function of the actual position of the rotor 14 and of the angular position of the rotor of the rotatory servo motor 20, a predetermined force can be generated which simulates a forward or rearward stop of the lever 10 and a predetermined flow of force during the simulation of the shifting touch during the simulated engaging of a gear by an operator. In this manner, it becomes possible, for example, to precisely simulate by way of the actuators 15, 20, the shifting haptics of a mechanical H-shifting transmission which is known or defined by way of parameters.

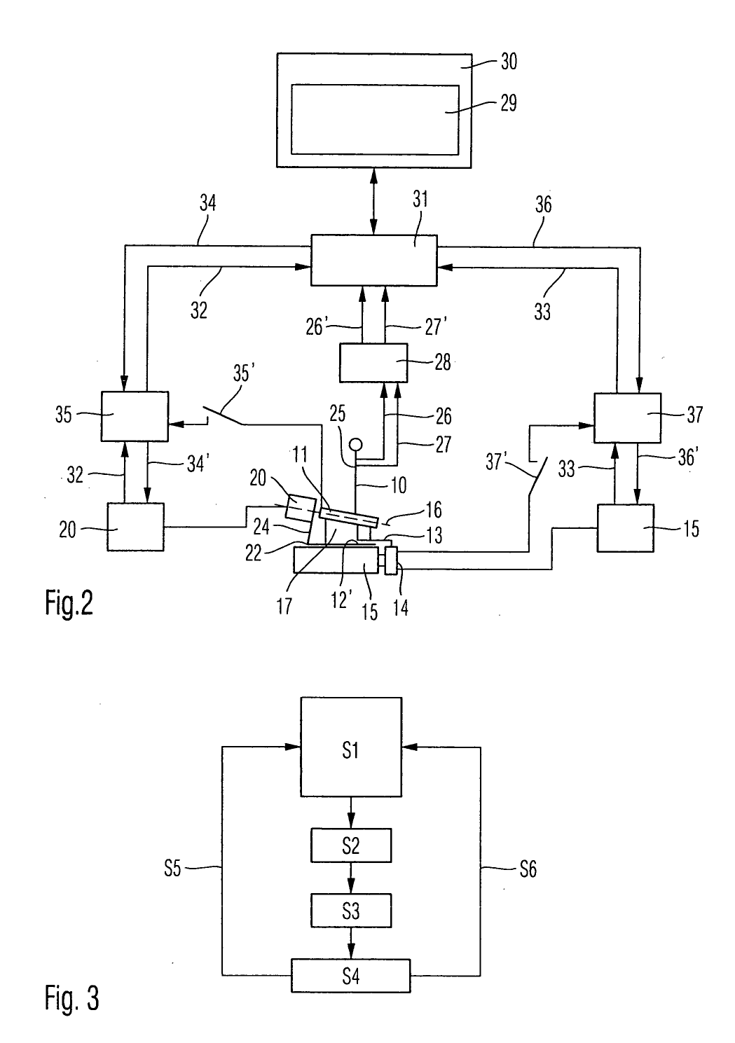

FIG. 2 is a schematic block diagram of the overall system of the simulation arrangement. In a simplified manner, FIG. 2 shows the arrangement according to FIG. 1 with the lever 10 of the first and second axis of rotation 11, 16, the rotatory servo motor 20, the linear motor 15, whose rotor 14 is coupled by way of the connecting rod 13 with the lower end 12′ of the lever 10, and with the rigid carrier device 17, 22, 24. According to the embodiment in FIG. 2, a force-measuring device 25 is provided on the lever and preferably consists of two strain gauges, for detecting the forces acting upon the lever 10. The force acting upon the lever results in a slight bending of the lever 10 which, in turn, is detected by the strain gauge, and correspondingly an indirect measurement of the force takes place by way of an electric characteristic of the strain gauge. The actual force values 26, 27, each for one force direction, generated by the force detection device 25 are preferably raised in their level in a measuring amplifier 28.

According to FIG. 2, the rotatory servo motor 20 and the linear motor 15 are again illustrated in the block diagram by means of a separate block. A computer device 29, preferably a real-time computer, which is programmed with a force controller and in which a mathematical transmission model with predetermined parameters is implied, is integrated, for example, in a HOST PC 30. By way of an interface device 31, which is preferably integrated in the computer device 29, an actual angular position 32 of the rotor of the rotatory servo motor 20 as well as an actual position 33 of the rotor 14 of the linear motor 15 is transmitted to the computer device 29. Also the amplified force-measuring signals 26′, 27′ of the measuring amplifier 28 are transmitted by way of the interface device 31 to the computer device 29.

By means of the actual angular position 32 and the actual position 33, a desired current value 34 at a driver end stage 35 of the rotatory servo motor 20 and a desired current value 36 at a driver end stage 37 of the linear motor 15 are computed and emitted in the computer device 29, preferably with the force measuring values 26′, 27′ amplified in the signal level for both movement directions of the lever 10. The desired current values 34, 36 are raised in their level to amplified current signals 34′, 36′ in the driver end stages 35, 37. Reference switches or final position switches 35′ 37′ of the motors 15, 20 are preferably connected to the driver end stages 35, 37 for switching these on/off. The control currents 34′, 36′ generate a predetermined torque or a predetermined force in a predetermined direction in the electric servo motors 20, 15.

In the computer device 29, predetermined forces are indicated for this purpose in real time, mainly as a function of the actual position 33 as well as the actual angular position 32, by the servo motors 15, 20, which predetermined forces have to be applied by an operator, preferably by an operating person, for displacing the lever 10 from the present actual position. Thus, in a simple manner, the haptics of an arbitrary manual transmission can be copied and simulated for an operating person.

FIG. 3 is a schematic block diagram for explaining the method of operation of a preferred embodiment of the present invention. A flow of force S1 computed in a computer device 29 according to FIG. 2 in real time at a desired position change of the lever 10 is transmitted to a force controller S2. The force controller S2 is preferably implemented by means of software on the computer device 29. The force controller S2 emits a desired current value which is in each case fed to a driver end stage S3. The desired current value amplified in the driver end stages S3 is then transmitted to the actuators S4, in the present case, to the electric servo motors of the mechanical section of the shifting simulator according to FIG. 1. As feedback variables, actual position values S5 of the lever 10 according to FIG. 1 and actual force values S6, which are applied to the lever 10, are fed to the computer device for computing the flow of force, in order to compute desired values for controlling the servo motors 15, 20 according to FIG. 1 in real time.

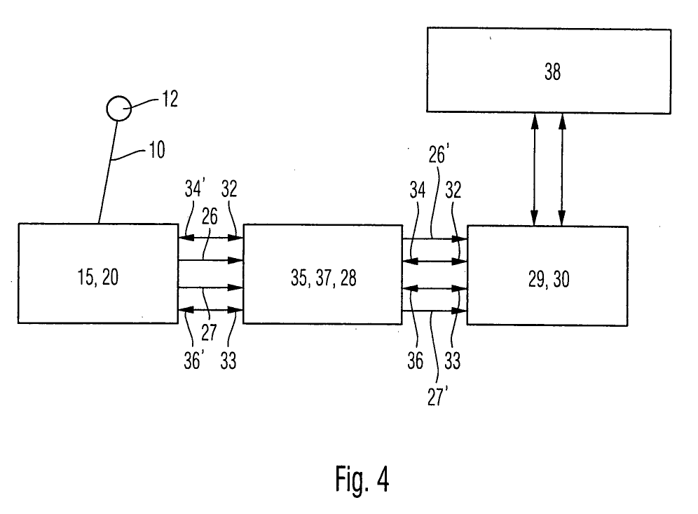

FIG. 4 is a schematic block diagram in which various function groups are combined. The gear shift lever 10 with the upper end 12 is prevented in the manner explained above by way of the rotatory servo motor 20 and the linear motor 15 from carrying out certain position changes or, with the application of a predetermined force, is enabled to change the position. The servo motors 15, 20 have integrated devices (not shown) for the precise determination of the position of their corresponding rotors; that is, particularly the actual angular position 32 as well as the actual position 33. These are transmitted, like the actual force values 26, 27 detected by way of the force measuring device 23 which are applied to the lever 10, by way of driver end stages 35, 37 to the computer device 29, for example, in a Host PC 30 or to a measuring amplifier 28 as amplified measuring signals 26′ 27′.

By way of a user surface 38, a software tool for considering and changing predetermined data or parameters, the behavior and thus particularly the operating haptics can be configured which are generated in the computer device 29 by means of a mathematical model. Desired current values 34, 36 computed by means of the mathematical model while defining predetermined parameters are transmitted by the computer device 29 to the corresponding driver end stages 35, 37 and are converted there to amplified current control signals 34′, 36′ for controlling the motors 15, 20.

Although the present invention was described above by means of a preferred embodiment, it is not limited thereto but can be modified in many fashions. In the embodiment described with respect to FIG. 2, which has the force detection device 25 on the lever 10 for generating a control variable or feedback variable, it is basically also conceivable to infer only on the basis of the actual angular position 32 as well as the actual position 33 of the rotors of the servo motors 20, 15 with reference to the actual desired current values 34, 36, which are directly proportional to the actually applied torque or to the actually applied force.

Furthermore, the block formation in the individual block diagrams should be considered as an example. Control signals and desired values can be present at the individual devices as current levels, as voltage levels and/or as digital words, fed, for example, by way of an optical waveguide, the driver end stages 35, 37 emitting preferably current signals 34′, 36′. The present invention is also not only provided for the simulation of a manual transmission of a motor vehicle but other preferred embodiments are contemplated for other operating devices, such as airplane or helicopter control devices.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. System for the simulation of a manual operating device, comprising:
a lever with an upper and a lower end which has a first axis of rotation extending essentially perpendicular to the longitudinal dimension of the lever and a second axis of rotation extending essentially perpendicular to the first axis of rotation and to the longitudinal dimension of the lever,
a rotatory servo motor which is coupled on a servo motor rotor side to the second axis of rotation of the lever, for providing a predetermined torque at a predetermined actual angular position or actual speed of the lever, and
a linear motor which is coupled on a linear motor rotor side with the lever, for providing a predetermined force at a predetermined actual position or actual angular position of the lever.

2. Simulation system according to claim 1, wherein the rotatory servo motor is coupled directly to the second axis of rotation and the linear motor is coupled by way of a connecting rod to a lower end of the lever, the lever extending with the lower end beyond the first axis of rotation.

3. Simulation system according to claim 1, wherein the linear motor and the rotatory servo motor are each connected to a driver stage for providing a predetermined current as a function of the respective actual-position/angular position of the lever.

4. Simulation system according to claim 2, wherein the linear motor and the rotatory servo motor are each connected to a driver stage for providing a predetermined current as a function of the respective actual-position/angular position of the lever.

5. Simulation system according to claim 1, wherein a common interface device is provided for the output of one desired current value respectively as a function of the actual position of the linear motor and of the angular position of the rotatory servo motor.

6. Simulation system according to claim 2, wherein a common interface device is provided for the output of one desired current value respectively as a function of the actual position of the linear motor and of the angular position of the rotatory servo motor.

7. Simulation system according to claim 3, wherein a common interface device is provided for the output of one desired current value respectively as a function of the actual position of the linear motor and of the angular position of the rotatory servo motor.

8. Simulation system according to claim 4, wherein a common interface device is provided for the output of one desired current value respectively as a function of the actual position of the linear motor and of the angular position of the rotatory servo motor.

9. Simulation system according to claim 5, wherein the interface device is connected with a computer device for the detection of actual values and the computation and output of desired values in real time, preferably consisting of a unit.

10. Simulation system according to claim 9, wherein a force detection device for detecting at least one feedback variable for the computation of the desired values in the computer device is provided on the lever.

11. Simulation system according to claim 10, wherein the force detection device has strain gauges and preferably measuring amplifiers for detecting the bending of the lever.

12. Simulation system according to claim 6, wherein the interface device is connected with a computer device for the detection of actual values and the computation and output of desired values in real time, preferably consisting of a unit.

13. Simulation system according to claim 12, wherein a force detection device for detecting at least one feedback variable for the computation of the desired values in the computer device is provided on the lever.

14. Simulation system according to claim 13, wherein the force detection device has strain gauges and preferably measuring amplifiers for detecting the bending of the lever.

15. Simulation system according to claim 7, wherein the interface device is connected with a computer device for the detection of actual values and the computation and output of desired values in real time, preferably consisting of a unit.

16. Simulation system according to claim 15, wherein a force detection device for detecting at least one feedback variable for the computation of the desired values in the computer device is provided on the lever.

17. Simulation system according to claim 16, wherein the force detection device has strain gauges and preferably measuring amplifiers for detecting the bending of the lever.

18. Simulation system according to claim 8, wherein the interface device is connected with a computer device for the detection of actual values and the computation and output of desired values in real time, preferably consisting of a unit.

19. Simulation system according to claim 18, wherein a force detection device for detecting at least one feedback variable for the computation of the desired values in the computer device is provided on the lever.

20. Simulation system according to claim 19, wherein the force detection device has strain gauges and preferably measuring amplifiers for detecting the bending of the lever.

21. Simulation system according to claim 1, wherein the lever, the linear motor and the rotatory servo motor are mutually mechanically coupled by way of a rigid carrier device.

22. Simulation system according to claim 2, wherein the lever, the linear motor and the rotatory servo motor are mutually mechanically coupled by way of a rigid carrier device.

23. Simulation system according to claim 3, wherein the lever, the linear motor and the rotatory servo motor are mutually mechanically coupled by way of a rigid carrier device.

24. Simulation system according to claim 4, wherein the lever, the linear motor and the rotatory servo motor are mutually mechanically coupled by way of a rigid carrier device.

25. Simulation system according to claim 5, wherein the lever, the linear motor and the rotatory servo motor are mutually mechanically coupled by way of a rigid carrier device.

26. Simulation system according to claim 8, wherein the lever, the linear motor and the rotatory servo motor are mutually mechanically coupled by way of a rigid carrier device.

27. Method of simulating a manual operating device, comprising:
providing a lever having and upper and a lower end, and a first axis of rotation being situated essentially perpendicular to a dimension of the lever, and the second axis of rotation being situated essentially perpendicular to the first axis of rotation and to the dimension of the lever;
providing a predetermined force at a predetermined actual position of the lever by means of a linear motor which is coupled on a linear motor rotor side with the lever, and
providing a predetermined torque at a predetermined angular position of the lever in the direction of the second axis of rotation by a rotatory servo motor which is coupled on the servo motor rotor side to the second axis of rotation of the lever.

28. Simulation method according to claim 27, wherein one desired force/torque value of the motors respectively is determined by means of a mathematical model in real time on a computer device as a function of an actual position of the linear motor, of the angular position of the rotatory servo motor and of an actual force acting upon the lever, one desired force/torque value of the motors respectively being determined by means of a mathematical model in real time on a computer device.

29. Simulation method according to claim 28, wherein the force/torque value computed in real time is transmitted by way of a force/torque controller to a control device which, in each case, controls one motor end stage of the linear motor and of the rotatory servo motor for providing a corresponding current for the force/torque generation.

30. Simulation method according to claim 27, wherein data and parameters, which, during the simulation, are generated and/or required and/or processed, are monitored and/or changed by way of an operating surface as a software tool on a computer device, preferably by means of a Host PC.

31. Simulation method according to claim 28, wherein data and parameters, which, during the simulation, are generated and/or required and/or processed, are monitored and/or changed by way of an operating surface as a software tool on a computer device, preferably by means of a Host PC.

32. Simulation method according to claim 29, wherein data and parameters, which, during the simulation, are generated and/or required and/or processed, are monitored and/or changed by way of an operating surface as a software tool on a computer device, preferably by means of a Host PC.

33. Simulation method according to claim 27, wherein shifting haptics of a real motor vehicle transmission are simulated.

34. Simulation method according to claim 28, wherein data and parameters, which, during the simulation, are generated and/or required and/or processed, are monitored and/or changed by way of an operating surface as a software tool on a computer device, preferably by means of a Host PC.

35. Simulation method according to claim 29, wherein data and parameters, which, during the simulation, are generated and/or required and/or processed, are monitored and/or changed by way of an operating surface as a software tool on a computer device, preferably by means of a Host PC.

36. Simulation method according to claim 30, wherein data and parameters, which, during the simulation, are generated and/or required and/or processed, are monitored and/or changed by way of an operating surface as a software tool on a computer device, preferably by means of a Host PC.

37. Simulation method according to claim 33, wherein a simulated driving speed and/or tractive resistances, particularly air friction and/or a gradient, and/or the position of a simulated clutch and/or a rotational engine speed and/or distortions in the transmission line during simulated cornering also flow into the simulation of the shifting haptics for a motor vehicle transmission.

38. Simulation method according to claim 34, wherein a simulated driving speed and/or tractive resistances, particularly air friction and/or a gradient, and/or the position of a simulated clutch and/or a rotational engine speed and/or distortions in the transmission line during simulated cornering also flow into the simulation of the shifting haptics for a motor vehicle transmission.

39. Simulation method according to claim 35, wherein a simulated driving speed and/or tractive resistances, particularly air friction and/or a gradient, and/or the position of a simulated clutch and/or a rotational engine speed and/or distortions in the transmission line during simulated cornering also flow into the simulation of the shifting haptics for a motor vehicle transmission.

40. Simulation method according to claim 27, wherein a feedback variable is obtained by way of strain gauges on the lever, which feedback variable is used during a desired-value determination for controlling the motors in a computer device.

41. Simulation method according to claim 28, wherein a feedback variable is obtained by way of strain gauges on the lever, which feedback variable is used during a desired-value determination for controlling the motors in a computer device.

42. Simulation method according to claim 29, wherein a feedback variable is obtained by way of strain gauges on the lever, which feedback variable is used during a desired-value determination for controlling the motors in a computer device.

43. Simulation method according to claim 30, wherein a feedback variable is obtained by way of strain gauges on the lever, which feedback variable is used during a desired-value determination for controlling the motors in a computer device.

44. Simulation method according to claim 33, wherein a feedback variable is obtained by way of strain gauges on the lever, which feedback variable is used during a desired-value determination for controlling the motors in a computer device.

45. Simulation method according to claim 37, wherein a feedback variable is obtained by way of strain gauges on the lever, which feedback variable is used during a desired-value determination for controlling the motors in a computer device.

46. System for simulating haptics of a manually operated vehicle transmission, comprising:
a manually operable shifting lever which is pivotally supported for movement about first and second pivot axes,
a first servo motor operable to apply first predetermined forces to said lever in response to movement of the lever about the first pivot axis, and
a second servo motor operable to apply second predetermined forces to said lever in response to movement of the lever about the second pivot axis.

47. System according to claim 46, comprising:
computer means for controlling said first and second predetermined forces as a function of movement of the lever in accordance with a computer program simulating a vehicle transmission operation.
